(19) United States
(12) Patent Application Publication
(10) Pub. No.: US 2003/0046836 A1
(43) Pub. Date: Mar. 13, 2003

(54) Cup having a rotary display part

(75) Inventor: Seung-mok Baek, Incheon (KR)

Correspondence Address: SKJERVEN MORRILL LLP, 25 METRO DRIVE, SUITE 700, SAN JOSE, CA, 95110, US

(73) Assignee: Zeus Tech. Co. Ltd.

(21) Appl. No.: 09/971,982

(22) Filed: Oct. 5, 2001

(30) Foreign Application Priority Data
Sep. 12, 2001 (KR) 28023/2001

(51) Int. Cl. G09F 3/00

(52) U.S. Cl. 40/324

(57) ABSTRACT

Providing a cup having a hollow part in the lower potion of it, in which rotary display part rotating in a certain direction (or both direction) is disposed, and the rotation of the display part becomes to be rotated when it is light, the rotation is stopped when it is no light, and it is stopped when it is no light, or the rotation of the display part is stopped when it is light by lift of the cup as a cup is about the ground, and when it is rotated the rotation of the display part from lifting of the cup, the luminary becomes to be emitted light for certain time.

Therefore, the present invention is available to realize a dynamic expression outward so that the use of the cup can be prompted by inducing user's interest.

And the present invention can attempt to maximize the effect of advertisement by showing content (for example, the content of advertisement) expressed on the rotary display part to the user more clearly.

In addition, the present invention can minimize the power consumption of the battery by stopping the rotation of the rotary display part at night or in the room without lighting.

Furthermore the present invention can deliver a particular sense to user by the use of light source which emits light during a limited span after the lift of the cup.

### BACKGROUND OF THE INVENTION

1.Field of the Invention

The present invention relates to a cup having a rotary display part. More particularly, the present invention relates to a transparent cup being equipped with a hollow part in the lower potion of it, in which a rotary display part is disposed. The rotary display part can be rotated in a certain direction (or both direction) and then, it is rotated when there is light or stopped when there is no light, and it is stopped when there is no light as a cup is about the ground or rotated when there is light as lifted the cup, and the light source is emitted light for certain time when the rotary display part becomes to be rotated from lifting of the cup.

2. Description of the Related Art

Generally a cup that is adapted to receive a water or a beverage is being manufactured in various shapes such as a drum type, a square type, a bell type, a triangle type, etc by using various materials such as glass, synthetic resin, metal, etc. and has a elegant design by adapting various diagrams expressed integrally or printed on its surface. However, cups with a transparent material and a simple drum type, which has an opened upper potion and a closed bottom portion, are mostly in use.

However in those cups with transparent material and simple drum type, the sense of functionality or aesthetics is insufficient so that inconveniences to express the fashioned character diagram on its surface to make up for insufficiency. If the character diagram is not expressed on surface of a cup, most of the children including babies are reluctant to use it. In addition, they are only provided as a simple means to receive a water or a beverage at the time to serve guest.

Meanwhile, companies to sell liquefied goods such as alcoholic liquors company, the milk company, a beverage company, etc offer sell-promoting cups of transparent material and simple drum type on free of charge to step up publicity of their goods. In such a case, it is common that letters or diagrams which indicate company's name, a trademark, etc are labeled or printed on the surface of the cup.

But, in response to the static advertising by labeled or printed letters and diagrams on the surface of the cup as described above, the user just catch a glimpse at the cup. Thus, it is difficult to attract public gaze continuously with engaging user's interest. Therefor there is a shortage which the effect of advertisement is lowered.

### SUMMARY OF THE INVENTION

Thus, it is an object of the present invention to provide a cup having a hollow part in the lower potion of it, in which rotary display part rotating in a certain direction is disposed, and the rotary display part can be rotated in a certain direction (or both direction) and then, it is rotated when there is light or stopped when there is no light, and it is stopped when there is no light as a cup is about the ground or rotated when there is light as lifted the cup, and the luminary is emitted light for certain time when the rotary display part becomes to be rotated from being lifted the cup.

The present invention is available to realize a dynamic expression outward so that the use of the cup can be prompted by attracting user's interest. And the present invention can attempt to maximize the effect of advertisement by showing content (for example, the content of advertisement) expressed on the rotary display part to the user more clearly.

In addition, the present invention can minimize the power consumption of the battery by stopping the rotation of the rotary display part at night or in the room without lighting.

Furthermore the present invention can deliver a particular sense to user by the use of light source which emits light during a limited span after the lift of the cup.

### BRIEF DESCRIPTION OF THE DRAWINGS

FIG. 1 is a perspective view showing the structure of the cup having a rotary display part according to an embodiment of the present invention.

FIG. 2 is a exploded perspective view showing the structure of the cup having rotary display part according to an embodiment of the present invention.

FIG. 3 is a sectional view showing the structure of the cup having rotary display part according to an embodiment of the present invention.

FIG. 4 is a plane view showing the structure of the cup having a rotary display part according to an embodiment of the present invention.

FIG. 5 is a bottom view showing the structure of the cup having rotary display part according to an embodiment of the present invention.

### DESCRIPTION OF THE PREFERRED EMBODIMENTS

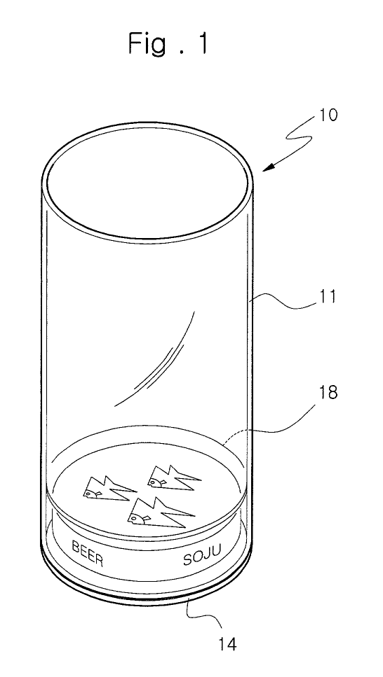

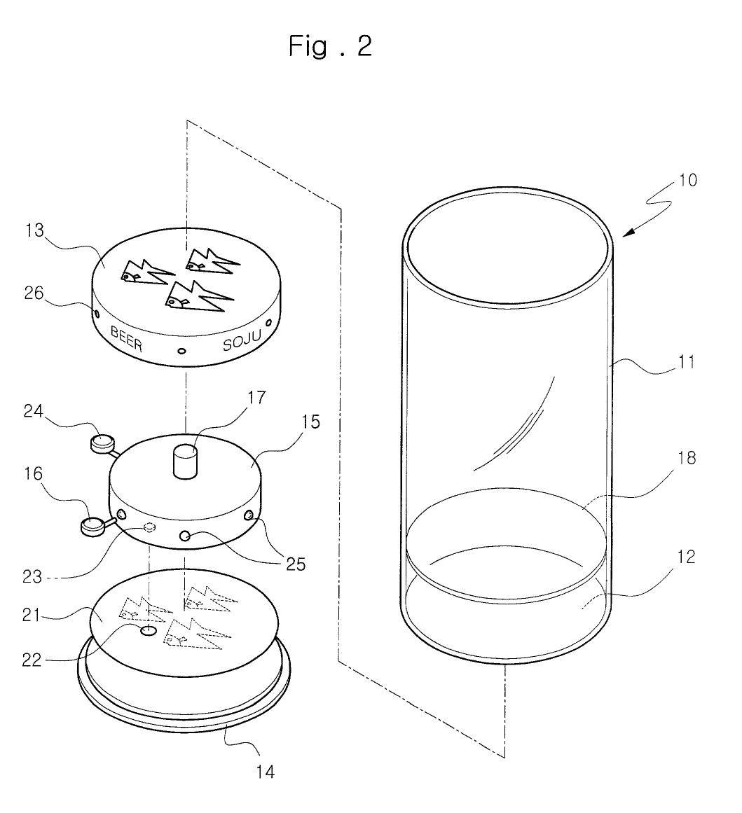

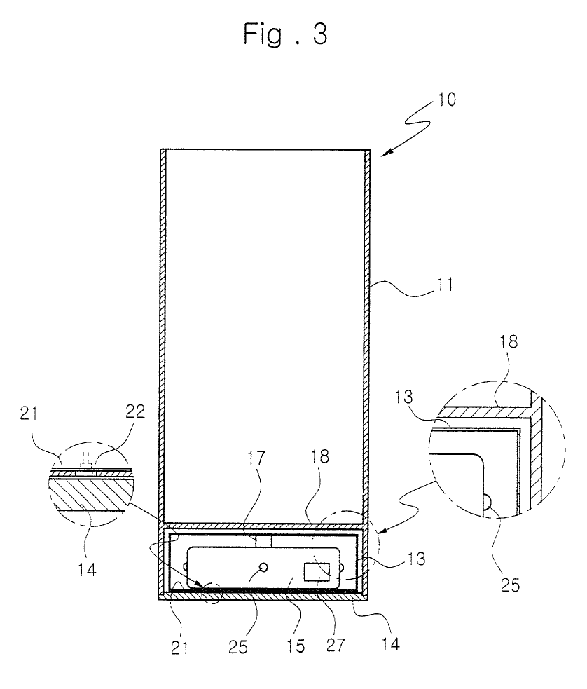

Referring to FIG. 1 through FIG. 5, a cup 10 in accordance with the present invention includes a hollow part 12 being equipped in the lower potion of it.

Movement 15 which contains an electric motor (not shown) and a reduction gear (not shown), rotating battery 16, and cylindrical rotary display part 13 which has opened bottom are installed interior to the hollow part 12.

The front part of axis 17 which projected upward from the movement 15 is mechanically connected to the center potion of the rotary display part 12 thereby rotation of the rotary display part 12 is available.

The bottom of the hollow part 12 is sealed using a base plate 14 and the upper face and side face of the rotary display part 13 can be shown through the main body 11.

An indicating sheet 21 is placed on the base plate 14, on which a light passing hole 22 with a predetermined radius is provided.

To control a driving state of the movement 15, a optical sensor 23 for detecting a light from outer side is disposed.

A plurality of light source 25 are installed on the side face of the movement 15, and the light source 25 emit light during a limited span after the cup 10 is lifted.

To deliver a light from the light source 25 to outside, a plurality of light passing hole 26 are provided on the side face of the rotary display part 13 with a predetermined distance.

Timer 27 for controlling a supply of power from light-emitting battery 24 is provided interior to movement 14 so that the light emitting operation of light source 25 is occurred during a limited span after the cup 10 is lifted.

Although the base plate 14 can be fixed to the bottom of cup 10 by ultrasonic welding so that the seal is accomplished tightly, but it is preferred to provide screwing part so that the base plate 14 can be attached or detached..

That is, it is possible to change the battery as the upper projection portion of the base plate 14 is placed the rubber packing.

And a printed circuit board(not shown) to electrically connect timer 27, optical sensor 23, rotating battery 16, and light emitting battery 24 each other is installed interior to movement 15.

Here, it is proper to embody the light source 25 with LED(Light Emitted Device).

Also, it is not limited such portion as displaced the light sensor 23 to the bottom face of movement 15.

That is, amount of electricity consumption of battery for rotating can be minimized because the rotary display part 13 is rotated when a circumference intensity of illumination is sensed by optical sensor 23, is stopped when a circumference intensity of illumination is not sensed by optical sensor 23, as optical sensor 23 sensing a intensity of illumination in circumference is placed interior to movement 15 to rotate the rotary display part 13, and

Non-described member with reference number 18 is interior bottom of transparent material.

Referring to drawings attached, the operation of the embodiment of the present invention will be described as follow.

At first, characters are printed or content of advertisement as like figure, letter, etc are expressed on the upper and side face of rotary display part 13. Thereafter, the rotary display part 13 is mechanically connected to the axis of movement 15, which an electrical motor, a reduction gear, and timer 27 are contained therein and optical sensor 23 is installed in its bottom and light source 25 is installed on side face.

On the condition that rotating battery 16 for supplying power to ensure rotation of the rotary display part 13 and light emitting battery 24 for supplying power to ensure light emitting of the light source 25 are connected to movement 15, movement 15, battery 16, 24, and rotary display part 13 are disposed interior to the hollow part 12.

Thereafter, the base plate 14 is attached tightly to the bottom of the hollow part 12 using ultra-sonic welding while indicating sheet 21 on which a specified content to match with the content of character, figure, and letter printed upper and side face of the rotary display part 13 are placed.

The hollow part 12 of the cup 10 remained in fully sealed state by attachment of the base plate 14

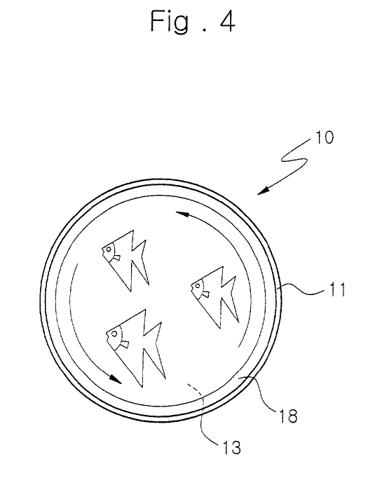

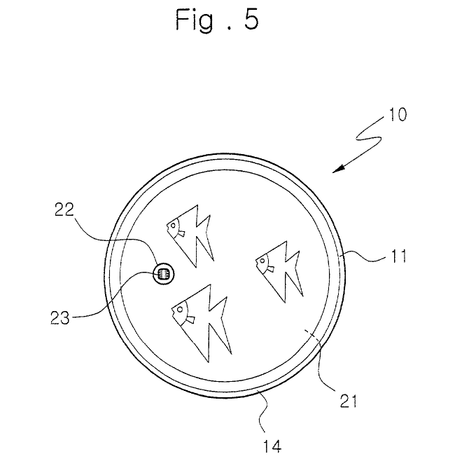

Therefore, as shown in FIG. 4 and FIG. 5, the rotary display part 13 which is connected to the axis 16 of the movement 15 powered by battery 16 at the time the cup 10 is used rotates at a constant speed (for example 20 turn per minute) so that not only content of advertisement, character diagram, etc, which displayed on the upper and side face can be expressed outside but also content of advertisement, character diagram, etc which displayed on the indication plate 21 can be expressed outside.

That is, on the upper and side face dynamic advertisement is possible by the rotation of the rotary display part 13 and in the bottom of the cup 10 stationary advertisement is possible.

Here, although it is not shown, the base plate 14 can be attached or detached by providing rubber packing on the upper curved part of the base plate 14 so that battery exchange is available

There is light passing hole 22 are equipped on the part of indication sheet 21, and the position of light passing hole 22 is in a row with optical sensor 23 which installed in the bottom of movement 15.

In addition, a plurality of light passing hole 26 are installed in predetermined distance in the part of the indication plate 21 to deliver the light emitted from lighting source 25 to outside.

Since the position of the light passing hole 26 is varied in accordance with the rotation of rotary display part 13, the pass-through of the light from the light source 25 is done selectively.

That is, when the light source 25 and light passing hole 26 are positioned in a row, pass-through of the light is available. But in the other case, pass-through of the light is not available.

Here, light-emitting time of the light source 25 in accordance with the lifting of the cup 10, is determined by timer 27 disposed interior to the movement 15.

Meanwhile, optical sensor 23 installed in the bottom of the movement 15 detects the brightness around the cup 10. Optical sensor 23 cause the rotary display part 13 to stop when it is dark around the cup 10 like at night or when the cup 10 is closed to the ground.

That is, when the brightness detected by optical sensor 23 is dark or when optical sensor 23 cannot detect the brightness because the cup 10 is closed to the ground, the optical sensor 23 cause the supply of the power from the rotating battery 16 to be cut off..

Because the rotary display part 13 is stopped, the power consumption of the rotating battery 16 can be minimized.

As described above, the present invention provides a cup having a hollow part in the lower potion of it, in which rotary display part rotating in a certain direction is disposed, and the rotation of the display part is stopped when it is dark abound of the cup or when the cup 10 is closed to the ground.

The present invention is available to realize a dynamic expression outward so that the use of the cup can be prompted by inducing user's interest.

And the present invention can attempt to maximize the effect of advertisement by showing content (for example, the content of advertisement) expressed on the rotary display part to the user more clearly.

In addition, the present invention can minimize the power consumption of the battery by stopping the rotation of the rotary display part at night or in the room without lighting.

Furthermore the present invention can deliver a particular sense to user by the use of light source which emits light during a limited span after the lift of the cup.

It must be understood that the present invention is not limited to illustrated embodiment, and various modifications are possible by those skilled in the art without departing from the spirit of the present invention, and those modifications are in the scope of claims disclosed.

What is claimed;

1. a cup made of transparent material, comprising;
a hollow part being equipped in the lower potion of the cup;
a movement disposed interior to the hollow part and for containing electric motor and reduction gear;
a battery for rotation of the movement;
a rotary display part which the upper and side face are exposed outside and the below is opened, and the front part of the axis of the movement is mechanically connected to the center part of the rotary display part to ensure its rotation; and
a base plate for sealing the hollow part and a indication sheet on which particular content is printed can be placed.

2. A cup in accordance with claim 1, wherein the indication sheet has a light passing hole with predetermined radius provided and further comprising; a optical sensor installed in the bottom of the movement for sensing a brightness around the cup and then controlling the rotation of the movement in accordance with the brightness sensed.

3. A cup in accordance with claim 1, further comprising;
a plurality of light source installed on the side face of the movement for emitting light during a span after the lift of the cup.
